(19) United States
(12) Patent Application Publication
(10) Pub. No.: US 2013/0289944 A1
(43) Pub. Date: Oct. 31, 2013

(54) System and method for signal processing

(71) Applicant: Ghassan Ayesh, Redwood City, CA (US)

(72) Inventor: Ghassan Ayesh, Redwood City, CA (US)

(21) Appl. No.: 13/815,848

(22) Filed: Mar. 15, 2013

Related U.S. Application Data
(60) Provisional application No. 61/637,861, filed on Apr. 25, 2012.

(51) Int. Cl. H04B 15/00

(52) U.S. Cl. CPC H04B 15/00
USPC 702/195; 702/194

(57) ABSTRACT

In one embodiment, a method for reducing signal noise and generating features includes the steps of receiving a discrete signal, transforming the discrete signal, using a processor, into a non-linear feature space, classifying the non-linear feature space, using the processor, into a set of non-linear feature sub-spaces, and performing a mathematical operation, using the processor, on the non-linear feature space and the set of non-linear feature sub-spaces, to produce an output feature set.

### PRIORITY CLAIM

Applicants hereby claim the benefit of provisional patent application No. 61/637,861, filed Apr. 25, 2012, the disclosure of which is hereby incorporated herein by reference as if set forth fully herein.

### TECHNICAL FIELD

The invention relates generally to the signal processing field, and more particularly to a signal processing method and system that involves transforming signals, classifying signals, and producing feature sets.

### BACKGROUND

A common problem facing signal processing systems is noise. Prior art signal processing methods and systems use feature extractors in an attempt to address this problem. However, these methods and systems for feature extraction suffer significantly from challenges which limit their ability to classify accurately. First, these methods and systems for feature extraction face an accuracy performance challenge in that they are limited in how well they can generalize based on earlier exposure to training data. Second, these methods and systems face a speed performance challenge in that they are significantly limited in how fast they can train. Third, these methods and systems face a scalability challenge in that they are limited in terms of how much they can learn through training.

Thus, there is a need in the signal processing field to create an improved new and useful method and system for reducing signal noise and performing feature extraction on an input signal.

### OVERVIEW

Described herein, in accordance with certain embodiments, are systems and methods for reducing signal noise and generating features, including receiving a discrete signal, transforming said discrete signal into a non-linear feature space, classifying said non-linear feature space into a set of nonlinear feature sub-spaces, and performing a mathematical operation on said non-linear feature space and said set of non-linear feature sub-spaces, to produce an output feature set.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a flow diagram of a method for reducing signal noise and generating features in accordance with certain embodiments;

FIG. 1A are plots of various wavelets that can be applied in the transformation of the incoming signal in accordance with certain embodiments;

FIG. 1B is a block diagram of a system 100 for performing the procedures of FIG. 1 for reducing signal noise and generating features in accordance with certain embodiments;

FIG. 2, is a flow diagram of a method as disclosed herein that includes inputting a portion of the output feature set into a classifier to produce a classified output signal in accordance with certain embodiments.

FIG. 2A is a block diagram of a system for performing some of the procedures of FIG. 2 in accordance with certain embodiments

FIG. 3 is a flow diagram of a signal processing approach that includes the steps of pre-processing of a discrete signal and storing a portion of the output feature set in an associative memory to produce a stimulus feature set in accordance with certain embodiments;

FIG. 3A is a flow diagram showing details of the step of generating a memory recall feature space in accordance with certain embodiments;

FIG. 3B is a block diagram of a system for performing some of the procedures of FIG. 3 in accordance with certain embodiments.

FIG. 4 is a flow diagram of a processing technique for reducing signal noise that includes performing a singular value decomposition on the non-linear feature space in accordance with certain embodiments;

FIG. 4A is a block diagram of a system for performing some of the procedures of FIG. 4 in accordance with certain embodiments;

FIG. 5 is a flow diagram of a method for reducing signal noise and generating features using dynamic thresholding in accordance with certain embodiments;

FIG. 5A is a block diagram of a system for performing some of the procedures of FIG. 5 in accordance with certain embodiments;

FIG. 6 is a flow diagram of a method for reducing signal noise and generating features using dynamic thresholding that includes inputting a portion of the output feature set into a classifier to produce a classified output signal in accordance with certain embodiments;

FIG. 6A is a block diagram of a system for performing some of the procedures of FIG. 6 in accordance with certain embodiments;

FIG. 7 is a flow diagram of a method for reducing signal noise and generating features using dynamic thresholding that includes storing a portion of the output feature set in an associative memory to produce a stimulus feature signal in accordance with certain embodiments; and

FIG. 7A is a block diagram of a system for performing some of the procedures of FIG. 7 in accordance with certain embodiments.

### DESCRIPTION OF EXAMPLE EMBODIMENTS

Example embodiments are described herein in the context of hardware and software processing modules. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

The term “exemplary” is used exclusively herein to mean “serving as an example, instance or illustration.” Any embodiment described herein as “exemplary” is not necessarily to be construed as preferred or advantageous over other embodiments.

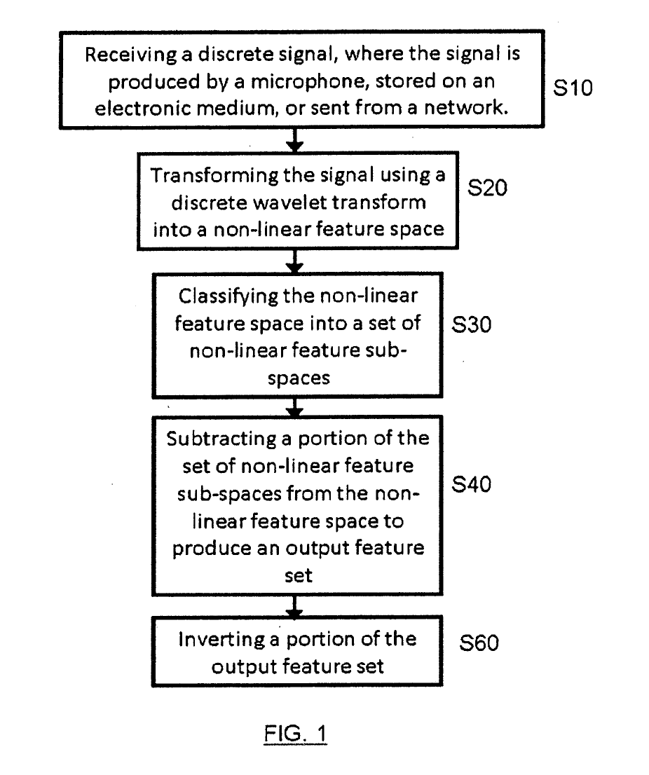

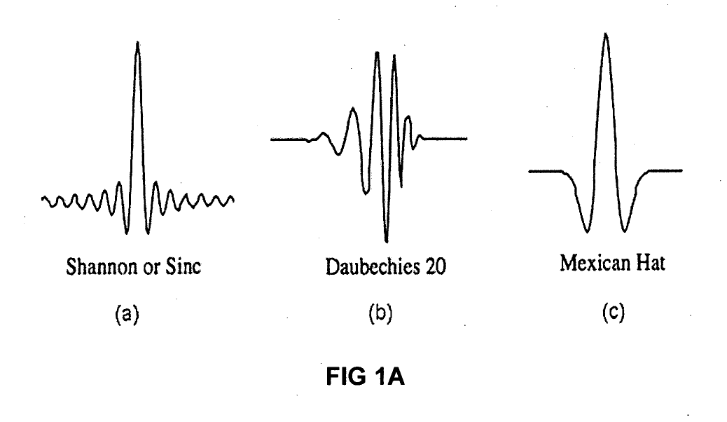

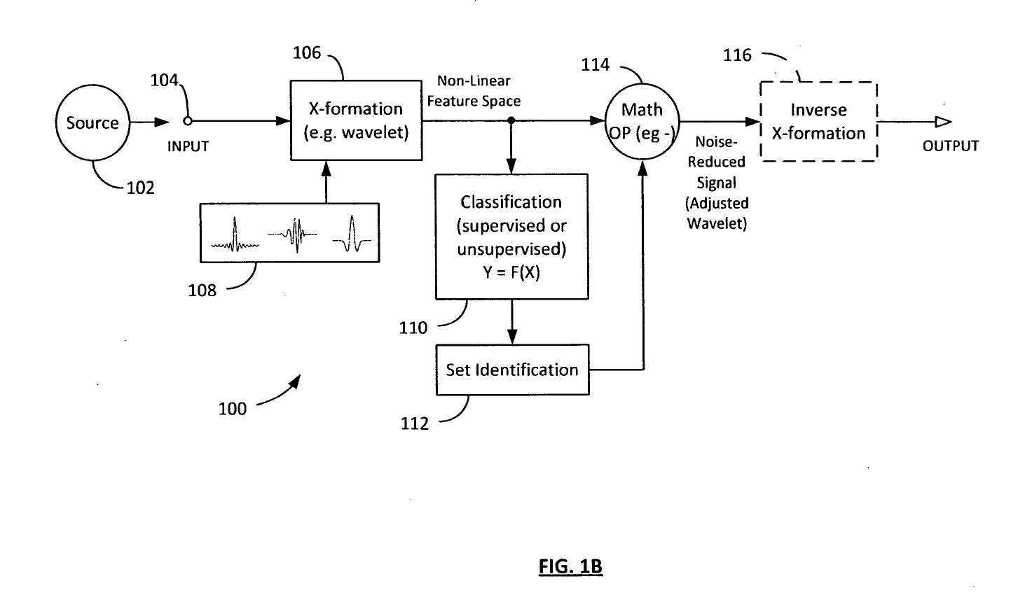

As shown in FIG. 1, a method for reducing signal noise and generating features includes: (a) receiving a discrete signal (Step S10), (b) transforming the discrete signal, using for example a processor or software or hardware module, into a non-linear feature space (Step S20), (c) classifying the non-linear feature space into a set of nonlinear feature sub-spaces (Step S30), and (d) performing a mathematical operation on the non-linear feature space and a set of non-linear feature sub-spaces, to produce an output feature set (Step S40). One or more of these procedures can be performed by a suitably programmed processor. The combination of these steps, S10, S20, S30, and S40, may be referred to as a method of signal pre-processing (Step S50).

The step of receiving a discrete signal (Step S10) functions to capture an input into the system. The step may include receiving an audio file. Alternatively, the step may include receiving a video file, text file, multimedia file or any information or data file. The signal may be received from an internal memory, an external memory, any electronic medium, a network, or any suitable method or device for storing or generating a signal. In the case of an audio file, the signal may also be received from a microphone. The signal produced by the microphone may be processed before being received by the claimed system. For example, the audio signal may be processed by an analog-to-digital converter or any other suitable method or device. In the case of a video or a multimedia signal, a portion of the signal may be received from a camera, a microphone, or any suitable method or device for receiving such a signal.

The step of transforming the discrete signal (Step S20) using a processor may include transforming the signal using a wavelet transform. The wavelet transform transforms the signal into a time-scale magnitude representation of the input signal. This time-scale magnitude representation is a multi-dimensional feature representation of the signal input.

Wavelet transforms allow for the granular manipulation of individual scale values of various magnitudes in various times. This manipulation may not disturb the other scale values also present in the input signal. In transforming the input signal, the wavelet transform causes the production of a set of approximations and a set of details. Approximations are high-scale, low-frequency elements of the signal. Details are low-scale, high-frequency elements of the signal. Compared to other known transforms, the use of a wavelet transform may offer advantages. For instance, wavelet transforms may provide further signal resolution than do many other transforms. In particular, wavelet transforms identify the scale, time, and magnitude of the input signal, while many other transforms may only identify a subset of these feature sets.

In contrast to transforms such as Fourier transforms which utilize periodic and oscillating functions of time or space called waves, wavelet transforms utilize wavelets, which are localized waves. Wavelets are localized in that their energy is concentrated in time or space. This localized feature of wavelets makes them especially suited to the analysis of transient signals.

Some examples of wavelets are shown in FIG. 1A. Derived wavelets, such as the Daubechies wavelet, are derived numerically. Crude wavelets, such as the Shannon and Mexican Hat wavelets, are wavelets that may be represented by a mathematical function. The Shannon mother wavelet, an example of a crude wavelet, is given by the equation:

$${Ψ}^{( Sha )} ( w ) = \prod ( \frac{w - 3 π / 2}{π} ) + \prod ( \frac{w + 3 π / 2}{π} )$$

The wavelet transform may be derived from the mother wavelet equation in the case of crude wavelets.

Two types of wavelet transforms are discrete wavelet transforms and continuous wavelet transforms. Either one or a combination of these wavelet transforms may perform the transforming step herein.

A discrete wavelet transform describes any linear wavelet transform which is sampled discretely and often decimated.

A continuous wavelet transform is a more fine-grained and undecimated transform. The continuous wavelet transform allows for the mapping of an input signal into the wavelet space, where the signal can be represented more thoroughly without sacrificing information inherent in the input space.

A continuous wavelet transform (CWT) is used to divide a continuous-time function into wavelets. The continuous wavelet transform is able to construct a time-frequency representation of a signal that offers high quality time and frequency localization.

Mathematically, the continuous wavelet transform of a continuous, square-integrable function X, at a scale value of a>0 and translational value b can be expressed by the following equation:

$${X}_{w} ( a , b ) = \frac{1}{\sqrt{\vert a \vert}} {\int }_{- ∞}^{∞} x ( t ) {ψ}^{*} ( \frac{t - b}{a} ) d t$$

In the alternative, other transforms which transform any input space into a highly non-linear output feature space may be utilized in place of a wavelet transform.

The step of classifying the non-linear feature space (Step S30), using a processor in one embodiment, functions to process the non-linear feature space into multiple categories, using for example a neural classifier. In certain embodiments this step is performed by a classifier which is under control of a processor which maps or translates its input signal (here, the non-linear feature space) into categories. The step of classifying may be supervised or unsupervised.

Supervised learning is a process for determining the relationship between an input data space X and an output data space Y, both of which are known a priori. The relationship determined is the map function F(X)=Y and is determined from an analysis of the input data set and the output data set together. Since the dataset is labeled and the required output is known, the classifying method step uses this knowledge of the supervised required outcome for the input set in order to infer the map function satisfying a portion of the data set within an acceptable margin of error.

The step of classifying may be performed using a supervised neural network, and in particular a back propagation neural network in which there are multi-layer connected neural cells composed of an input layer, hidden layers(s), and the output layer. Alternatively, any other classifier capable of classifying a signal into multiple categories may be used to perform the classifying step.

Back propagation (BP) neural networks are supervised learning systems that require the presence of the input data space and the corresponding output data space for the training to take place. During learning each input vector is submitted to the BP neural network and the output of the network is measured against the required output vector to be learned for the corresponding input. The error is then fed into the network in order for the network to adjust itself.

Back propagation is a multi-stage dynamic optimization method that can work its way across the neural layers in order to adjust the weights according to the measured error. The system evolves over time to capture and learn to map the input data set with the required output dataset. This method of learning is used for neural networks that do not have backward connections or feedback loops and is suitable for the feed forward neural architectures.

Unsupervised learning is the process for determining the relationship, F(X)=Y, between an input data space X and an output data space Y, where Y is not entirely known a priori. Hence the unsupervised learning algorithm is tasked to find both F(X) and Y in this case based on inferences of hidden relationships in the input data space and discovering what the Y output data set should be. Hence, it is a non-explicit guided discovery of the output set along with the mapping function that maps F(X) into Y.

The step of performing a mathematical operation (Step S40) for example comprises the subtraction of an identified portion of the set of non-linear feature sub-spaces from the non-linear feature space. This entails the reduction of an identified noise sub-feature set from the feature set identified in the previous step. Alternatively, any suitable mathematical operation may be performed on the transformed signal and at least a portion of output signal from the classifying step such that noise present in the transformed signal is reduced.

In the instance where the transforming step is performed using a wavelet transform, the output of the performing mathematical operation step is referred to as the adjusted wavelet which represents a noise-reduced wavelet representation along with an optimal feature set representation.

The above approach for reducing signal noise and generating features may further include an inverting step (Step S60), whereby the output feature set is input into an inverse transform in order to generate a de-noised signal. The inverse transform is the inverse of the transform utilized in the transforming step.

FIG. 1B is a block diagram of a system 100 for performing procedures such as those described hereinabove in accordance with certain embodiments. A signal from a source 102 is received at an input 104 for delivery to a transformation module 106. The input signal is transformed by module 106, for example using a wavelet transform 108, into a time-scale-magnitude representation thereof. A classification module 110 classifies the non-linear feature space output of the transformation module into multiple categories, and an identifier 112 selects an identified subset therefrom. A mathematical operation module 114 then operates on the transformed signal and at least a portion of the output signal (that is, a subset) from the classifying step such that noise present in the transformed signal is reduced. The resultant de-noised signal may then be inverse-transformed by an inverse transform module 116. One or more of these modules can entail a portion of a processor or circuit, or a dedicated, suitably-configured processor or circuit. Alternatively or in combination, one or more of these modules can comprise a software or firmware module.

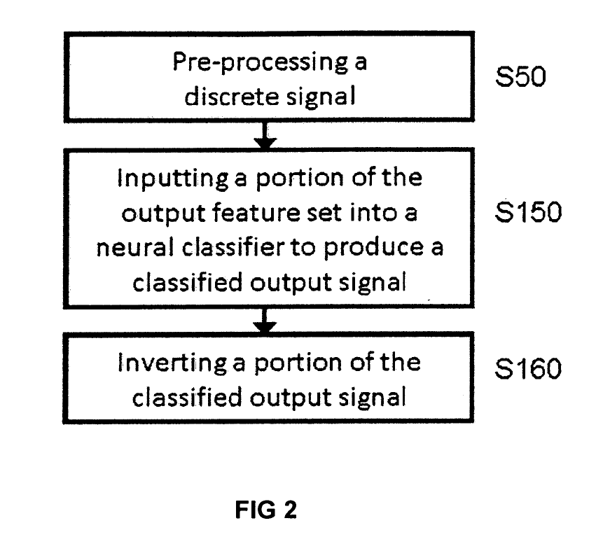

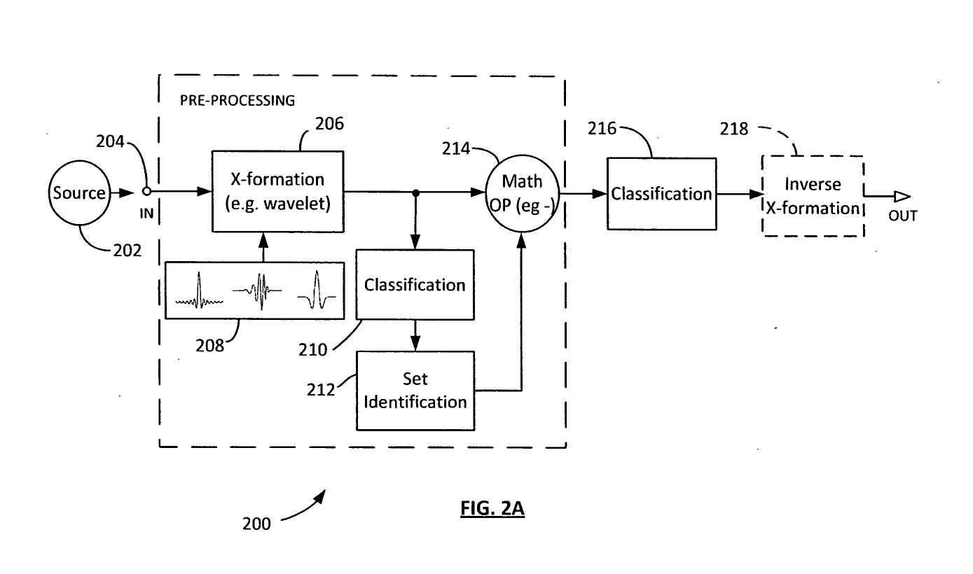

In certain embodiments, instead of sending the output feature set to an inverting step, the output feature set can alternatively be input into further stages of processing for purposes of voice recognition, transcription, command, control, event, user interactivity, or the like. For example, as shown in FIG. 2, a method as disclosed herein includes the steps of (a) pre-processing a discrete signal (Step S50), and (b) inputting a portion of the output feature set into a classifier to produce a classified output signal (Step S150).

The step of pre-processing a discrete signal (Step S50) comprises the sub-steps of receiving a discrete signal (Step S10), transforming the discrete into a non-linear feature space (Step S20), classifying the non-linear feature space into a set of non-linear feature sub-spaces (Step S30), and performing a mathematical operation on the non-linear feature space and the set of non-linear feature sub-spaces, to produce an output feature set (Step S40).

The step of inputting a portion of the output feature set into a classifier to produce a classified output signal (Step S150) preferably involves inputting the signal into a neural classifier. The neural classifier is similar to the neural classifier described above. In the alternative, any other classifier capable of classifying a signal into multiple categories may be used to perform the classifying step.

The method may further include the inverting of the classified output signal, wherein the classified output signal is input into an inverse transform in order to generate a de-noised signal (Step S160). Instead of inverting the classified output signal, the classified output signal can alternatively be input into further stages of processing for purposes of voice recognition, transcription, command, control, event, or user interactivity.

FIG. 2A is a block diagram of a system 200 for performing procedures such as those described hereinabove in accordance with certain embodiments. A signal from a source 202 is received at an input 204 for delivery to a transformation module 206. The input signal is transformed by module 206, for example using a wavelet transform 208, into a time-scale-magnitude representation thereof. A classification module 210 classifies the non-linear feature space output of the transformation module into multiple categories, and an identifier 212 selects an identified subset therefrom. A mathematical operation module 214 then operates on the transformed signal and at least a portion of the output signal (that is, a subset) from the classifying step such that noise present in the transformed signal is reduced. A further classifier 216 is applied to the output of the mathematical operation module 214. The resultant signal may then be inverse-transformed by an inverse transform module 218. One or more of these modules can entail a portion of a processor or circuit, or a dedicated, suitably-configured processor or circuit. Alternatively or in combination, one or more of these modules can comprise a software or firmware module.

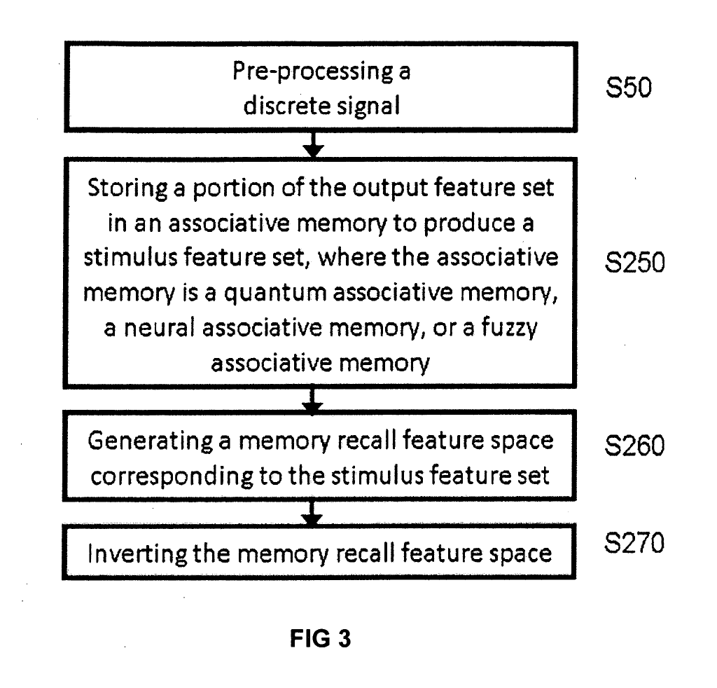

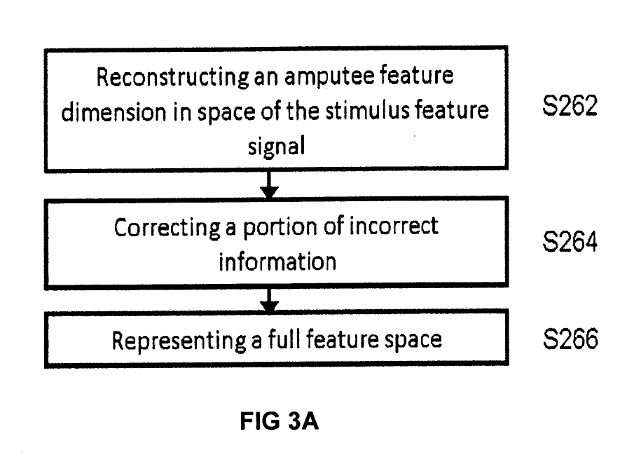

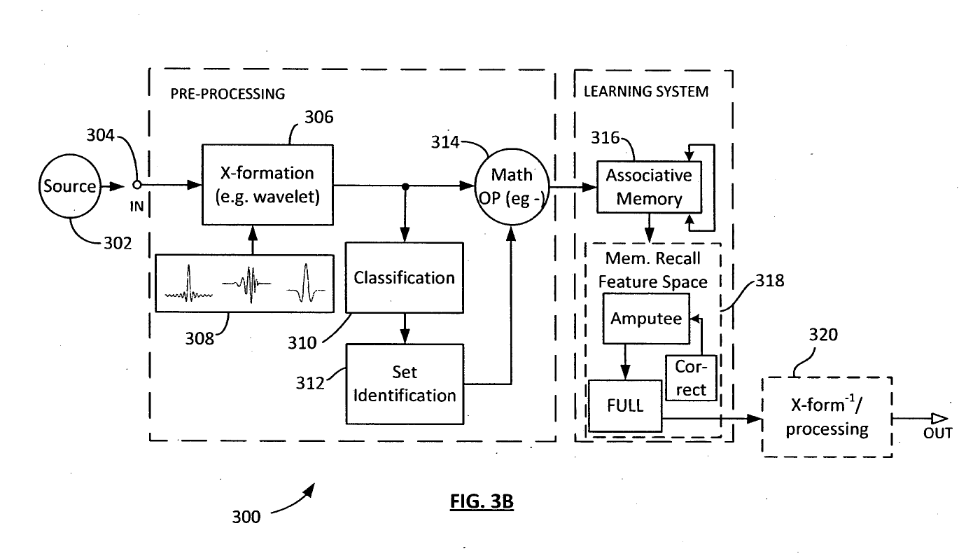

FIG. 3 is directed to a signal processing approach in accordance with certain embodiments, wherein the approach includes the steps of (a) pre-processing of a discrete signal (Step S50), and (b) storing a portion of the output feature set in an associative memory to produce a stimulus feature set (Step S250).

In certain embodiments, the step of pre-processing a discrete signal (Step S50) comprises the sub-steps of receiving a discrete signal (Step S10), transforming the discrete signal into a non-linear feature space (Step S20), classifying the non-linear feature space into a set of non-linear feature sub-spaces (Step S30), and performing a mathematical operation on the non-linear feature space and the set of non-linear feature sub-spaces, to produce an output feature set (Step S40), as described above.

A portion of the output feature set is stored in an associative memory to produce a stimulus feature set (Step S250). Associative memories are learning systems that associate input patterns into an output pattern that corresponds to the input pattern. Associative memories share the ability to provide missing or amputee parameter substitution for distortive input patterns. In an abstract form, every associative memory is a mapping function G(X)=X which maps the input space X onto itself as an output space through discovering hidden input space pattern properties.

Associative memories operate in two regimes, a training regime and a production regime. In the training regime, an input, X, may be stored in the associative memory:

X→X

In the production regime, a new input, X′, referred to as the stimulus, is input into the associative memory, which outputs the pattern, X, stored in memory that corresponds to the new input:

X′→X

The step of storing a portion of the output feature set in an associative memory preferably utilizes a quantum associative memory. A quantum associative memory is an associative memory capable of high density memory storage of input patterns through the utilization of quantum mechanical physical properties. A quantum associative memory is similar in its basic function to other associative memories in the sense that it is a memory system that is able to store input patterns and recall these input patterns in response to encountering similar input patterns that it had stored before.

Alternatively, a neural associative memory, a fuzzy associative memory, or any suitable method or device that functions as an associative memory element, may be used in place of the quantum associative memory. A neural associative memory is an associative memory comprising an artificial neural network. A fuzzy associative memory is an example of an artificial neural network having fuzzy-valued input patterns, fuzzy-valued output patterns, or fuzzy-valued connection weights.

The method of FIG. 3 may further include the step of generating a memory recall feature space corresponding to the stimulus feature signal (Step S260). As shown in FIG. 3A, the step of generating a memory recall feature space (Step S260) preferably includes reconstructing an amputee feature dimension in space of the stimulus feature signal (Step S262), correcting a portion of incorrect information (Step S264), and representing a full feature space (Step S266). Alternatively, the step of generating a memory recall feature space may be performed by any suitable method or device that can retrieve events or information from the past.

The step of reconstructing an amputee feature dimension in space of the stimulus feature signal (S262) preferably includes substituting a portion of missing information by utilizing memory recall by the associative memory based on what it has already learned from prior exposure to input patterns.

The step of correcting a portion of incorrect information (Step S264) includes memory recall by the associative memory based on what it has already learned based on prior exposure to input patterns.

The step of representing a full feature space (Step S266) includes representing the effective recall of the input pattern from the associative memory.

As shown in FIG. 3, the method according to this approach may further include the step of inverting the memory recall feature space (Step S270) where the memory recall feature space is input into an inverse transform in order to generate a de-noised signal which has had missing information completed and incorrect information corrected. This method with the step of inverting constitutes constructive regenerative signal processing filtering.

Instead of inverting the classified output signal, the classified output signal can alternatively be input into further stages of processing for purposes of voice recognition, transcription, command, control, event, or user interactivity.

FIG. 3B is a block diagram of a system 300 for performing some of the procedures described hereinabove in accordance with certain embodiments. A signal from a source 302 is received at an input 304 for delivery to a transformation module 306. The input signal is transformed by module 306, for example using a wavelet transform 308, into a time-scale-magnitude representation thereof. A classification module 310 classifies the non-linear feature space output of the transformation module into multiple categories, and an identifier 312 selects an identified subset therefrom. A mathematical operation module 314 then operates on the transformed signal and at least a portion of the output signal (that is, a subset) from the classifying step such that noise present in the transformed signal is reduced.

An associative memory module 316 receives a portion of the output feature set, generating a memory recall feature space 318. An optional inverse transformer module 320 can invert the memory recall feature space to generate the system output.

One or more of these modules can entail a portion of a processor or circuit, or a dedicated, suitably-configured processor or circuit. Alternatively or in combination, one or more of these modules can comprise a software or firmware module.

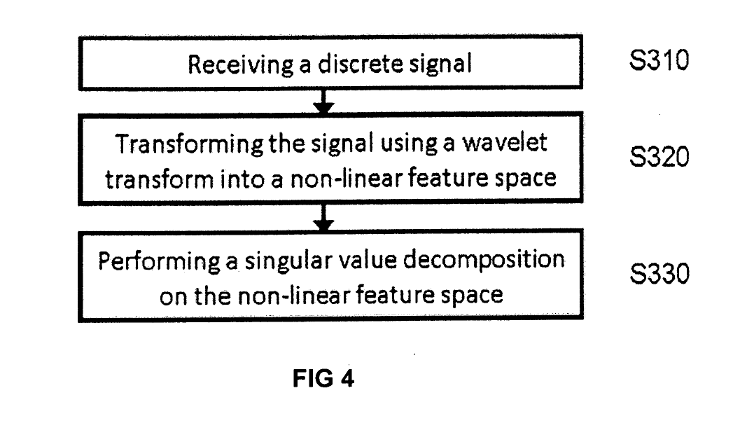

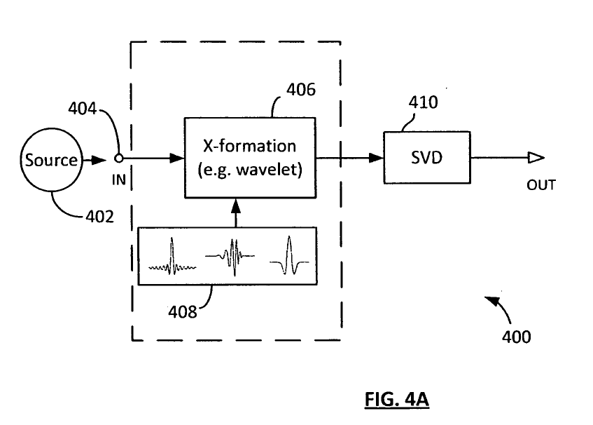

As shown in FIG. 4, one processing technique for reducing signal noise in accordance with certain embodiments herein may include the steps of (a) receiving a discrete signal (S310), as described above, (b) transforming the signal using a processor into a non-linear feature space (S320), also as described above, and (c) performing a singular value decomposition on the non-linear feature space (Step S330).

SVD is a method that reduces a set of correlated data points into a set of non-correlated data points exposing the unique points which possess the highest variation that represent the data set. This means that SVD can compress the data set and reduce the dimensionality of the data.

SVD decomposes an input matrix into three matrices: a left orthogonal matrix, a sorted diagonal matrix, and a right orthogonal transpose matrix. In equation form, this is represented by:

Aₘₙ=UₘₘSₘₙV^{T}ₙₙ,

where the left orthogonal matrix U is a left eigenvector matrix, the middle diagonal matrix S is the singular sorted square roots of the eigenvalues from the left or right eigen-matrices, and the diagonal orthogonal matrix V, is a right eigenvector matrix.

The columns in U are the left singular vectors, and the columns in V are the right singular vectors. The columns in both the U and V matrices are orthonormal column vectors. The ability to decompose any triangular matrix into these three important components of a matrix is the result of the singular value decomposition method.

FIG. 4A is a block diagram of a system 400 for performing some of the procedures described hereinabove in accordance with certain embodiments. A signal from a source 402 is received at an input 404 for delivery to a transformation module 406. The input signal is transformed by module 406, for example using a wavelet transform 408, into a time-scale-magnitude representation thereof. The output of the transformation module is delivered to SVD module 410, which reduces a set of correlated data points received into a set of non-correlated data points, exposing the unique points which possess the highest variation that represent the data set. One or more of these modules can entail a portion of a processor or circuit, or a dedicated, suitably-configured processor or circuit. Alternatively or in combination, one or more of these modules can comprise a software or firmware module.

Further processing can then be performed as described above.

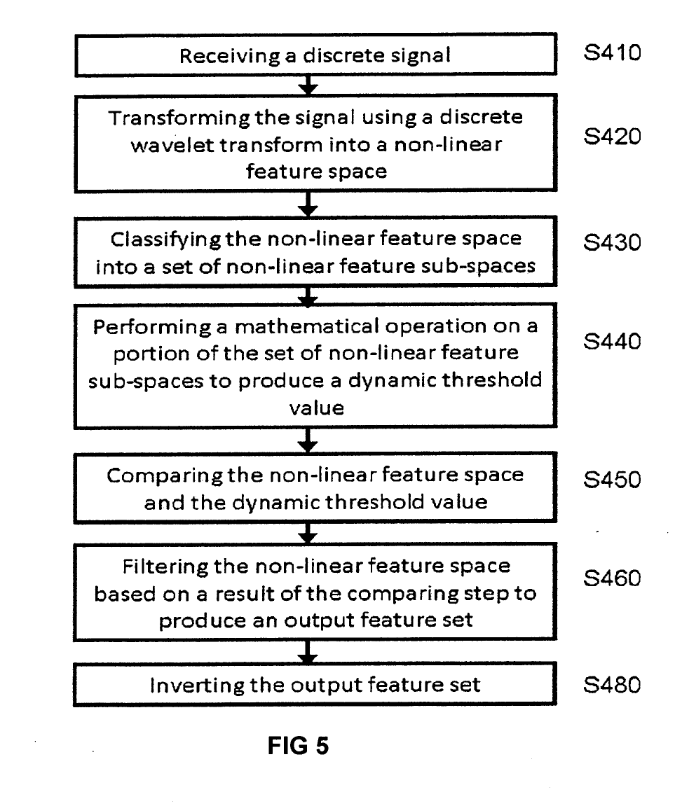

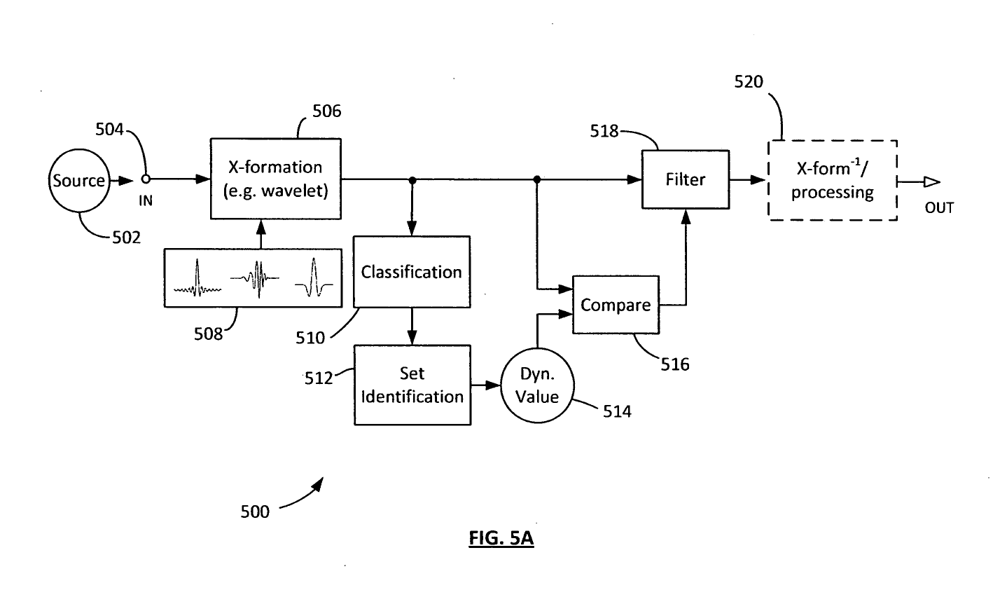

As shown in FIG. 5, a method for reducing signal noise and generating features using dynamic thresholding in accordance with certain embodiments includes: (a) receiving a discrete signal (S410), (b) transforming the discrete signal into a non-linear feature space (Step S420), and (c) classifying the non-linear feature space into a set of nonlinear feature sub-spaces (Step S430). These can be performed in the manner described above. The method for reducing signal noise and generating features using dynamic thresholding further includes (d) performing a mathematical operation on a portion of the set of non-linear feature sub-spaces to produce a dynamic threshold value (Step S440), (e) comparing the non-linear feature space and the dynamic threshold value (Step S450), and filtering the non-linear feature space based on a result of the comparing step to produce an output feature set (Step S460). The combination of these steps, S410, S420, S430, S440, S450, and S460, may be referred to as a method step of signal pre-processing using dynamic thresholding (Step S470).

The step of performing a mathematical operation, for example using a processor, on a portion of the set of non-linear feature sub-spaces to produce a dynamic threshold value (Step S440) in certain embodiments includes calculating the maximum value of the absolute value of the non-linear feature sub-spaces, the mean value of the absolute value of the non-linear feature sub-spaces, and the minimum value of the absolute value of the nonlinear feature sub-spaces. In the alternative, other mathematical operations that can be performed to calculate a dynamic threshold value by which the non-linear feature space may be filtered may be used in place of the maximum, minimum, and mean value operations.

After the dynamic threshold value is produced, a comparison is performed between the non-linear feature space and the dynamic threshold value (Step S450). This is a logical comparison where the non-linear feature space value is either less than, equal to, or greater than the dynamic threshold value.

The step of filtering the non-linear feature space based on a result of the comparing step to produce an output feature set (Step S460) may include removing any component of the non-linear feature space having a value below the dynamic threshold value. In the alternative, any filtering process which acts to remove components from the non-linear feature space may instead be used.

The method of reducing signal noise and generating features using dynamic thresholding may further include the step of inverting the output feature set (Step S480) where the output feature set is input into an inverse transform in order to generate a de-noised signal. The inverse transform is the inverse of the transform utilized in the transforming step (S420).

FIG. 5A is a block diagram of a system 500 for performing some of the procedures described hereinabove in accordance with certain embodiments. A signal from a source 502 is received at an input 504 for delivery to a transformation module 506. The input signal is transformed by module 506, for example using a wavelet transform 508, into a time-scale-magnitude representation thereof. The output non-linear feature set is delivered to a classifying module 510 for classification into a set of non-linear feature sub-spaces 512 as described above. A dynamic threshold value generator 514 uses a set of non-linear sub-space features to generate a dynamic threshold value used in a comparison by comparator 516 with the non-linear feature set from transformation module 506. The outcome of the comparison is used to provide filter parameters to filter 518, whose output is a feature set from which components having values below the dynamic threshold value for example are removed. An optional inverter 520 can then be provided, and/or further processing can ensue. One or more of these modules can entail a portion of a processor or circuit, or a dedicated, suitably-configured processor or circuit. Alternatively or in combination, one or more of these modules can comprise a software or firmware module.

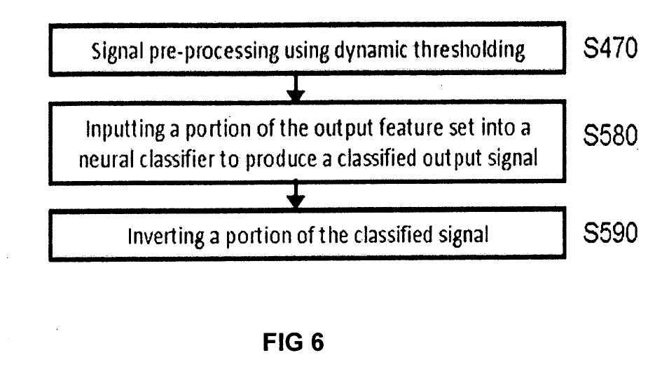

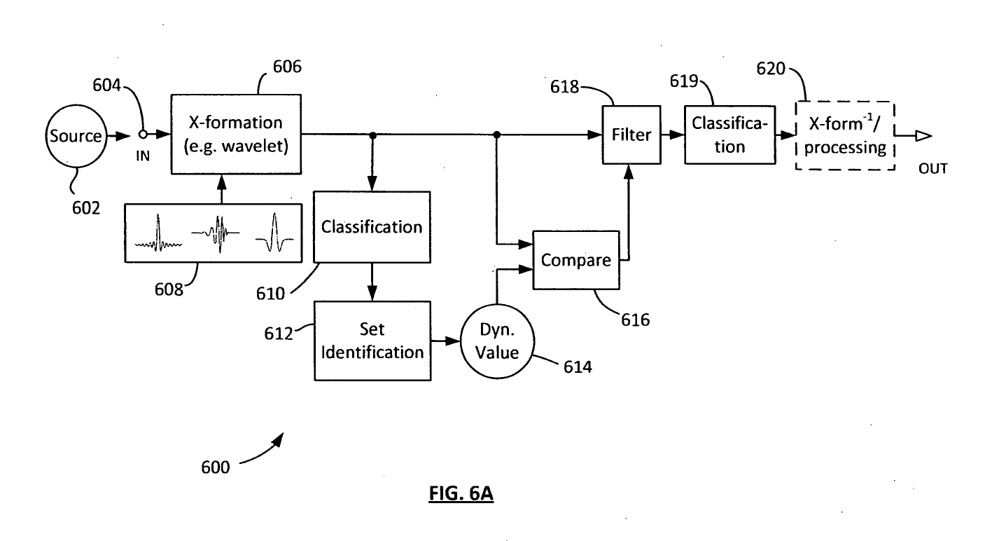

As shown in FIG. 6, a method for reducing signal noise and generating features using dynamic thresholding can include: (a) signal pre-processing using dynamic thresholding, and (b) inputting a portion of the output feature set into a classifier to produce a classified output signal.

The step of signal pre-processing using dynamic thresholding (Step S470) comprises the sub-steps of receiving a discrete signal (Step S410), transforming the discrete signal into a non-linear feature space (Step S420), classifying the non-linear feature space into a set of non-linear feature sub-spaces (Step S430), performing a mathematical operation on a portion of the set of non-linear feature sub-spaces to produce a dynamic threshold value (Step S440), (e) comparing the non-linear feature space and the dynamic threshold value (Step S450), and filtering the non-linear feature space based on a result of the comparing step to produce an output feature set (Step S460).

The step of inputting a portion of the output feature set into a classifier to produce a classified signal (Step S580) may be similar to the step of inputting a portion of the output feature set into a classifier to produce a classified signal (Step S150) described above.

A further step of inverting the classified signal (Step S590) where the classified signal is input into an inverse transform in order to generate a de-noised signal may then be carried out. The inverse transform is the inverse of the transform utilized in the transforming step (S420).

FIG. 6A is a block diagram of a system 600 for performing some of the procedures described hereinabove in accordance with certain embodiments. A signal from a source 602 is received at an input 604 for delivery to a transformation module 606. The input signal is transformed by module 606, for example using a wavelet transform 608, into a time-scale-magnitude representation thereof. The output non-linear feature set is delivered to a classifying module 610 for classification into a set of non-linear feature sub-spaces 612 as described above. A dynamic threshold value generator 614 uses a set of non-linear sub-space features to generate a dynamic threshold value used in a comparison by comparator 616 with the non-linear feature set from transformation module 606. The outcome of the comparison is used to provide filter parameters to filter 618, whose output is a feature set from which components having values below the dynamic threshold value for example are removed. A classification module 619, for example a neural classifier as described above, is operable to classify the filtered output. An optional inverter 620 can then be provided, and/or further processing can ensue.

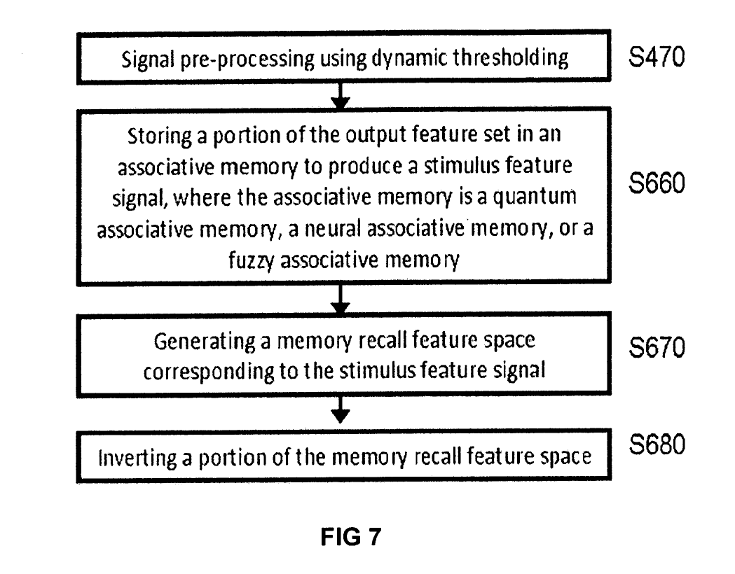

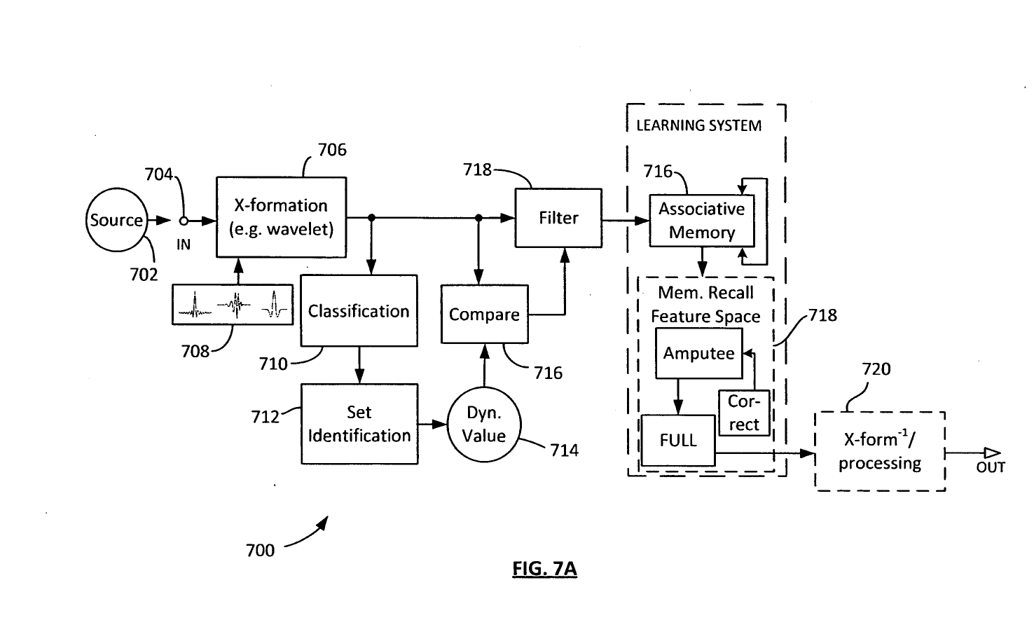

With reference to FIG. 7, a method for reducing signal noise and generating features using dynamic thresholding as disclosed herein may include: (a) signal pre-processing using dynamic thresholding, and (b) storing a portion of the output feature set in an associative memory to produce a stimulus feature signal.

The step of signal pre-processing using dynamic thresholding (Step S470) comprises the sub-steps of receiving a discrete signal (Step S410), transforming the signal, using a processor, into a non-linear feature space (Step S420), classifying the non-linear feature space, using the processor, into a set of non-linear feature sub-spaces (Step S430), performing a mathematical operation, using the processor, on a portion of the set of non-linear feature sub-spaces to produce a dynamic threshold value (Step S440), (e) comparing the non-linear feature space and the dynamic threshold value (Step S450), and filtering the non-linear feature space based on a result of the comparing step to produce an output feature set (Step S460).

The step of storing a portion of the output feature set in an associative memory to produce a stimulus feature signal (S660) may be identical to the step of storing a portion of the output feature set in an associative memory step (S250) described above.

The method may further include a step of generating a memory recall feature space corresponding to the stimulus feature signal (S670). This step may be identical to the step of generating a memory recall feature space corresponding to the stimulus feature set (S260) described above.

The method may further include a step of inverting a portion of the memory recall feature space (Step S680) where a portion of the memory recall feature space is input into an inverse transform in order to generate a de-noised signal. The inverse transform is the inverse of the transform utilized in the transforming step (S420).

FIG. 7A is a block diagram of a system 700 for performing some of the procedures described hereinabove in accordance with certain embodiments. A signal from a source 702 is received at an input 704 for delivery to a transformation module 706. The input signal is transformed by module 706, for example using a wavelet transform 708, into a time-scale-magnitude representation thereof. The output non-linear feature set is delivered to a classifying module 710 for classification into a set of non-linear feature sub-spaces 712 as described above. A dynamic threshold value generator 714 uses a set of non-linear sub-space features to generate a dynamic threshold value used in a comparison by comparator 716 with the non-linear feature set from transformation module 706. The outcome of the comparison is used to provide filter parameters to filter 718, whose output is a feature set from which components having values below the dynamic threshold value for example are removed. An associative memory 716 receives a portion of the output feature set, generating a memory recall feature space 718. An optional inverse transformer 720 can invert the memory recall feature space to generate the system output.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method for reducing signal noise and generating features, comprising the steps of:
receiving a discrete signal;
transforming said discrete signal into a non-linear feature space;
classifying said non-linear feature space into a set of nonlinear feature sub-spaces; and
performing a mathematical operation on said non-linear feature space and said set of non-linear feature sub-spaces, to produce an output feature set.

2. The method of claim 1, further comprising the step of:
inverting a portion of said output feature set.

3. The method of claim 1, wherein said step of transforming said discrete signal is accomplished using a wavelet transform.

4. The method of claim 3, wherein said wavelet transform is a discrete wavelet transform.

5. The method of claim 1, wherein said step of performing a mathematical operation comprises subtracting a portion of said set of non-linear feature sub-spaces from said non-linear feature space.

6. The method of claim 1, wherein said signal is selected from a group consisting of a signal produced by a microphone, a signal stored on an electronic medium, and a signal sent from a network.

7. The method of claim 1, further comprising the step of:
inputting a portion of said output feature set into a classifier to produce a classified output signal.

8. The method of claim 7, wherein said classifier is a neural classifier.

9. The method of claim 7, further comprising the step of:
inverting a portion of said classified output signal.

10. The method of claim 1, further comprising the step of:
storing a portion of said output feature set in an associative memory to produce a stimulus feature signal.

11. The method of claim 10, wherein the associative memory is selected from a group consisting of a quantum associative memory, a neural associative memory, and a fuzzy associative memory.

12. The method of claim 10, further comprising the step of:
generating a memory recall feature space corresponding to said stimulus feature signal.

13. The method of claim 12, wherein said step of generating a memory recall feature space comprises:
reconstructing an amputee feature dimension in space of said stimulus feature signal;
correcting a portion of incorrect information; and
representing a full feature space.

14. The method of claim 12, further comprising the step of inverting said memory recall feature space.

15. A method for reducing signal noise and generating features, comprising the steps of:
receiving a discrete signal;
wavelet transforming said discrete signal, using a processor, into a non-linear feature space;
classifying said non-linear feature space, using said processor, into a set of nonlinear feature sub-spaces; and
mathematically subtracting a portion of said non-linear feature sub-spaces from said non-linear feature space.

16. The method of claim 15, wherein said step of wavelet transforming said discrete signal is accomplished using a discrete wavelet transform.

17. A method for reducing signal noise, comprising the steps of:
receiving a discrete signal;
transforming said discrete signal, using a processor, into a non-linear feature space; and
performing a singular value decomposition on said non-linear feature space.

18. The method of claim 17, wherein said step of transforming said discrete signal is accomplished using a wavelet transform.

19. A method for reducing signal noise and generating features, comprising the steps of:
receiving a discrete signal;
wavelet transforming said discrete signal, using a processor, into a non-linear feature space;
classifying said non-linear feature space, using said processor, into a set of nonlinear feature sub-spaces;
performing a mathematical operation, using said processor, on said non-linear feature space and said set of non-linear feature sub-spaces to produce an output feature set;
storing a portion of said output feature set in an associative memory to produce a stimulus feature signal; and
generating a memory recall feature space corresponding to said stimulus feature signal.

20. The method of claim 19, wherein said step of performing a mathematical operation comprises subtracting a portion of said set of non-linear feature sub-spaces from said non-linear feature space.

21. A method for reducing signal noise and generating features using dynamic thresholding, comprising the steps of:
receiving a discrete signal;
transforming said discrete signal, using a processor, into a non-linear feature space;
classifying said non-linear feature space, using said processor, into a set of nonlinear feature sub-spaces;
performing a mathematical operation, using said processor, on a portion of said set of non-linear feature sub-spaces to produce a dynamic threshold value;
comparing said non-linear feature space and said dynamic threshold value; and
filtering said non-linear feature space based on a result of said comparing step to produce an output feature set.

22. The method of claim 21, further comprising the step of:
inverting said output feature set.

23. The method of claim 21, wherein said step of transforming said discrete signal is accomplished using a wavelet transform.

24. The method of claim 23, wherein said wavelet transform is a discrete wavelet transform.

25. The method of claim 21, further comprising the step of:
inputting a portion of said output feature set into a classifier to produce a classified signal.

26. The method of claim 25, wherein said classifier is a neural classifier.

27. The method of claim 25, further comprising the step of:
inverting a portion of said classified signal.

28. The method of claim 21; further comprising the step of:
storing a portion of said output feature set in an associative memory to produce a stimulus feature signal.

29. The method of claim 28, wherein said associative memory is selected from a group consisting of a quantum associative memory, a neural associative memory, and a fuzzy associative memory.

30. The method of claim 28, further comprising the step of:
generating a memory recall feature space corresponding to said stimulus feature signal.

31. The method of claim 30, wherein said step of generating a memory recall feature space comprises:
reconstructing an amputee feature dimension in space of said stimulus feature signal;
correcting a portion of incorrect information; and
representing a full feature space.

32. The method of claim 30, further comprising the step of:
inverting a portion of said memory recall feature space.

33. A computing system comprising:
an interface for receiving an input signal;
a processor coupled to said interface;
a memory coupled to said interface and coupled to said processor and containing instructions that cause said processor to:
transform said signal into a non-linear feature space;
classify said non-linear feature space into a set of non-linear feature sub-spaces;
perform a mathematical operation on a portion of said set of non-linear feature sub-spaces to calculate a dynamic threshold value;
compare said non-linear feature space and said dynamic threshold value; and
filter said non-linear feature space based on a result of said compare step.

34. The system of claim 33, wherein said interface is selected from a group consisting of a microphone interface, an electronic storage medium interface, and a network interface.

35. A computing system comprising:
an interface for receiving an input signal;
a processor coupled to said interface;
a memory, coupled to said interface and coupled to said processor, and containing instructions that cause the processor to:
transform said signal into a non-linear feature space;
classify said non-linear feature space into a set of non-linear feature sub-spaces; and
perform a mathematical operation on said non-linear feature space and said set of non-linear features sub-spaces resulting in an output feature set.

36. The system of claim 35, wherein said interface is selected from a group consisting of a microphone interface, an electronic storage medium interface, and a network interface.

37. A system comprising:
an input for receiving a discrete signal;
a transformation module operable to transform said discrete signal into a non-linear feature space;
a classifier operable to classify said non-linear feature space into a set of nonlinear feature sub-spaces; and
a mathematical operation module operable to perform a mathematical operation on said non-linear feature space and said set of non-linear feature sub-spaces, to produce an output feature set.

38. The system of claim 37, further comprising an inverter operable to invert a portion of said output feature set.

39. The system of claim 37, wherein the transformation module applies a wavelet transform to the discrete signal.

40. The system of claim 39, wherein the wavelet transform is a discrete wavelet transform.

41. The system of claim 37, wherein said received input signal is selected from a group consisting of a signal produced by a microphone, a signal stored on an electronic medium, and a signal sent from a network.

42. The system claim 37, further comprising an additional classifier operable to classify a portion of the output feature set.

43. The system of claim 42, wherein said additional classifier is a neural classifier.

44. The system of claim 42, further comprising an inverter operable to invert a portion of an output of the additional classifier.

45. The system of claim 37, further comprising an associative memory operable to store a portion of the output feature set to generate a stimulus feature signal.

46. The system of claim 45, wherein the associative memory is selected from a group consisting of a quantum associative memory, a neural associative memory, and a fuzzy associative memory.

47. A system comprising:
an input for receiving a discrete signal;
a transformation module operable to transform said discrete signal into a non-linear feature space;
a single value decomposition module operable to perform single value decomposition on said non-linear feature space.

48. The system of claim 47, wherein the transformation module applies a wavelet transform to the discrete signal.

49. The system of claim 48, wherein the wavelet transform is a discrete wavelet transform.

50. A system for reducing signal noise and generating features using dynamic thresholding, comprising:
an input for receiving a discrete signal;
a transformation module operable to transform said discrete signal into a non-linear feature space;
a classifier operable to classify said non-linear feature space into a set of nonlinear feature sub-spaces; and
a mathematical operation module operable to perform a mathematical operation on a portion of said non-linear feature subs-space, to produce a dynamic threshold value;
a comparator operable to compare said non-linear feature space and said dynamic threshold value; and
a filter operable to filter said non-linear feature space based on a result of said comparing step to produce an output feature set.

51. The system of claim 50, further comprising an additional classifier operable to classify a portion of the output feature set.

52. The system of claim 51, wherein said additional classifier is a neural classifier.

53. The system of claim 51, further comprising an inverter operable to invert a portion of an output of the additional classifier.

54. The system of claim 50, further comprising an associative memory operable to store a portion of the output feature set to generate a stimulus feature signal.
